(19) United States
(12) Patent Application Publication
(10) Pub. No.: US 2024/0176335 A1
(43) Pub. Date: May 30, 2024

(54) FAULT DETECTION METHOD FOR DETECTING BEHAVIOR DEVIATION OF PARAMETERS

(71) Applicant: UNITED MICROELECTRONICS CORP., Hsinchu (TW)

(72) Inventors: Yung-Yu Yang, Tainan City (TW); Kang-Ping Li, Tainan City (TW); Chih-Kuan Chang, Tainan City (TW); Chung-Chih Hung, Kaohsiung City (TW); Chen-Hui Huang, Hsinchu City (TW); Nai-Ying Lo, Kaohsiung City (TW); Shih-Wei Huang, Pingtung County (TW)

(21) Appl. No.: 18/433,511

(22) Filed: Feb. 6, 2024

Related U.S. Application Data
(62) Division of application No. 17/874,569, filed on Jul. 27, 2022.

(30) Foreign Application Priority Data
Jul. 1, 2022 (TW) 111124776

(51) Int. Cl. G05B 19/418; G05B 23/02

(52) U.S. Cl. CPC G05B 19/41865; G05B 23/0281; G05B 2219/45031

(57) ABSTRACT

A fault detection method, includes the following steps. A target sequence is received, the target sequence includes several data. A first moving average operation is performed on the target sequence to establish a first moving average sequence. A second moving average operation is performed on the target sequence to establish a second moving average sequence. A difference operation between the first moving average sequence and the second moving average sequence is performed to obtain a difference sequence, the difference sequence includes several difference values. An upper limit value is set. When one of the difference values is greater than the upper limit value, the target sequence is determines as abnormal.

This application is a divisional application of co-pending U.S. application Ser. No. 17/874,569, filed at Jul. 27, 2022, which claims the benefit of R.O.C. application Serial No. 111124776 filed at Jul. 1, 2022, the subject matter of which is incorporated herein by reference.

### TECHNICAL FIELD

The present disclosure relates to a fault detection method, and more particularly, relates to a fault detection method for detecting behavior deviation of parameters in Fault Detection and Classification (FDC).

### BACKGROUND

In a manufacturing process of a production line, whether the parameter variables of the process are abnormal maybe analyzed by Fault Detection and Classification (FDC). For example, in the semiconductor process, the parameter variables related to the silicon wafer process may be monitored, and the values of the parameter variables at different time points may be established as a time sequence, and the curve of such a time sequence maybe used as an “FDC control chart”. The FDC control chart is analyzed by fault detection classification to determine whether the parameter variables are abnormal.

The abnormal conditions of the parametric variables include: (1) The numerical range of the parametric variable does not change significantly, but the profile of the time sequence of the parametric variable has abnormal behavior (i.e., “behavior deviation”), and (2) the profile of the time sequence of parametric variables has no apparent abnormal behavior, but the time sequence of parametric variables has discontinuous conditions (i.e., “jump point” conditions).

However, when the parameter variables of the process of multiple targets are to be analyzed, lengths of the time sequences related to different targets are different from one another, or the time sequences are ahead or delayed with one another in time relationship, hence it is not easy to establish a standard sequence for normal condition. Furthermore, when the numerical variation of the parametric variable is large, a reasonable upper limit value (or a reasonable lower limit value) of the value of the parametric variable may not be set.

In order to overcome the above-mentioned technical problems, those skilled in this art are devoted to improve the fault detection method of parametric variables, and to process and calculate the time sequences of parameter variables. It is desired that numerical variation of time sequences may be reduced, and reasonable standard sequence may be established.

### SUMMARY

According to an embodiment of the present disclosure, a fault detection method is provided. The fault detection method includes the following steps. A target sequence is received, the target sequence includes several data. A first moving average operation is performed on the target sequence to establish a first moving average sequence. A second moving average operation is performed on the target sequence to establish a second moving average sequence. A difference operation between the first moving average sequence and the second moving average sequence is performed to obtain a difference sequence, the difference sequence includes several difference values. An upper limit value is set. When one of the difference values is greater than the upper limit value, the target sequence is determines as abnormal.

### BRIEF DESCRIPTION OF THE DRAWINGS

FIG. 1A is a schematic diagram of the first original sequence to be processed by the fault detection method according to an embodiment of the present disclosure.

FIG. 1B is a schematic diagram of the second original sequence to be processed by the fault detection method according to an embodiment of the present disclosure.

FIG. 2 is a schematic diagram of the DTW-operation performed by the first original sequence and the second original sequence.

FIG. 3 is a schematic diagram of the DBA-operation performed on the first original sequence and the second original sequence.

FIG. 4 is a schematic diagram showing that a plurality of original sequences related to L targets are performed with DBA-operation to obtain the standard sequence.

FIG. 5 is a schematic diagram of the total difference sequence established by the total difference values between the plurality of original sequences and the standard sequence in FIG. 4.

FIGS. 6A and 6B are schematic diagrams of the target sequence.

FIG. 7 is a schematic diagram of a first moving average sequence obtained by performing a first moving average operation on the target sequence of FIGS. 6A and 6B.

FIG. 8 is a schematic diagram of a second moving average sequence obtained by performing a second moving average operation on the target sequence of FIGS. 6A and 6B.

FIG. 9 is a schematic diagram of the difference sequence between the first moving average sequence and the second moving average sequence.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

### DETAILED DESCRIPTION

The fault detection method of the present disclosure may process a plurality of original sequences to detect abnormal conditions therein. The data included in the original sequences are raw data which are not processed yet. In the embodiments of the present disclosure, the original sequences to be processed at least include a first original sequence OS1 and a second original sequence OS2.

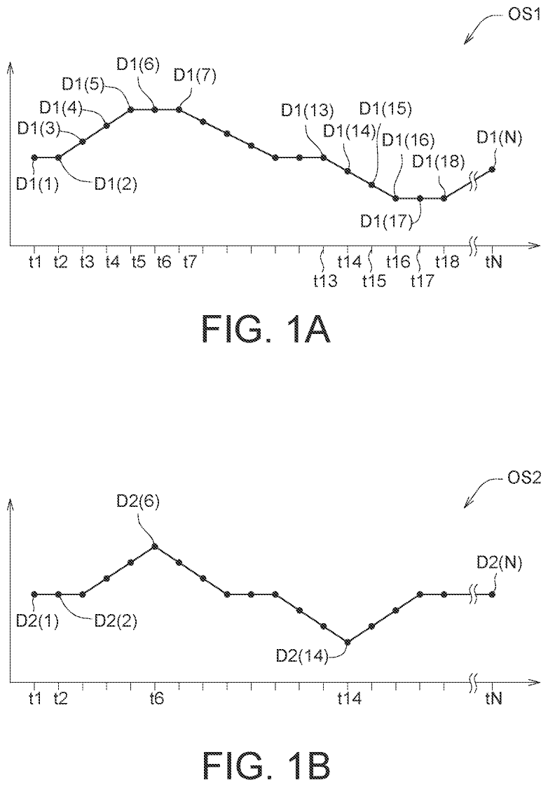

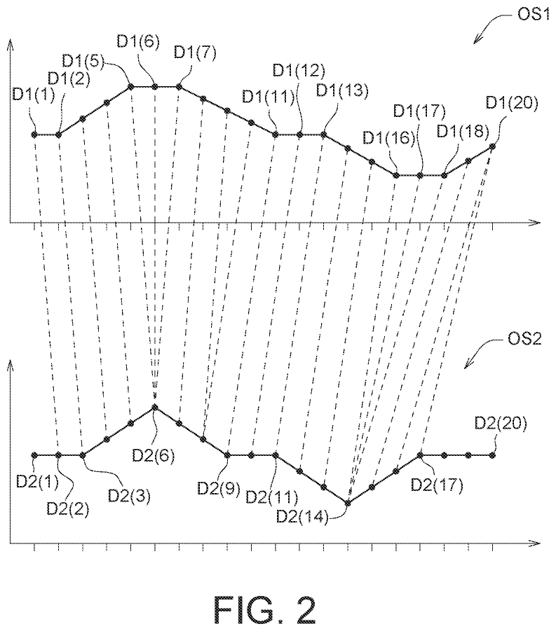

FIG. 1A is a schematic diagram of the first original sequence OS1 to be processed by the fault detection method according to an embodiment of the present disclosure. As shown in FIG. 1A, the first original sequence OS1 is a time sequence, including a plurality of first data D1(1), D1(2), . . . , D1(N), and the first data respectively correspond to a plurality of time points t1, t2, . . . , tN. The first data D1(1) corresponds to a time point t1, the first data D1(2) corresponds to a time point t2, and so on, the first data D1(N) corresponds to a time point tN.

The first original sequence OS1 is related to a first target A1. More specifically, in a manufacturing process of the first target A1, the processing equipment of the first target A1 has a plurality of parameter variables, including the first parameter variable P1. Values of the first parameter variable P1 at different time points may form the first original sequence OS1, that is, the first data D1(1)˜D1(N) included in the first original sequence OS1 are the corresponding values of the first parameter variable P1 at time points t1-tN.

Taking a process of silicon wafers as an example, to process a plurality of wafers in a batch, the first target A1 is, for example, one of the wafers. In the anneal process of the process of wafer, the first target A1 is placed in a temperature control box for heating and cooling. The first parameter variable P1 is, for example, the temperature of the temperature control box. The first data D1(1) of the first original sequence OS1 is the temperature at time point t1 when the temperature control box processes the first target A1, and the first data D1(2) is the temperature of the temperature control box at time point t2, and so on.

The marked points of the first data D1(1)-D1(N) of the first original sequence OS1 may be connected to form a profile. By analyzing the abnormality of the profile of the first original sequence OS1, a Fault detection and Classification (FDC) may be performed on the process of the first target A1.

The first data D1(1)˜D1(N) of the first original sequence OS1 have a trend of value changing corresponding to the time axis, which indicates a trend of value changing of the first parameter variable P1 corresponding to the time axis. For example, between the time point t2 and the time point t5, the first data D1(2)-D1(5) have an increasing trend. Between the time point t5 and the time point t7, the first original sequence OS1 reaches a local maximum value, (i.e., reaches the peak of the first original sequence OS1). The first data D1(5)-D1(7) corresponding to the time points t5-t7 are the local maximum values of the first original sequence OS1.

On the other hand, between the time point t13 and the time point t16, the first data D1(13)-D1(16) have a decreasing trend. Between the time point t16 and the time point t18, the first original sequence OS1 reaches a local minimum value, (i.e., reaches the valley of the first original sequence OS1). The first data D1(16)-D1(18) are the local minimum values of the first original sequence OS1.

From the above, at least one local maximum value and at least one local minimum value of the first original sequence OS1 may be located according to the trend of value changing of the first data D1(1)-D1(N).

FIG. 1B is a schematic diagram of the second original sequence OS2 to be processed by the fault detection method according to an embodiment of the present disclosure. As shown in FIG. 1B, the second original sequence OS2 includes a plurality of second data D2(1)-D2(N), respectively corresponding to a plurality of time points t1-tN.

The second original sequence OS2 is related to the second target A2. The second target A2 is different from the first target A1, and the second target A2 is, for example, another wafer. In the annealing process, the temperature of the temperature control box to process the second target A2 is the second parameter variable P2. The second data D2(1) of the second original sequence OS2 is the temperature of the temperature control box at time point t1 when the second target A2 is processed, the second data D2(2) is the temperature of the temperature control box at time point t2, and so on.

At time point t6, the second data D2(6) of the second original sequence OS2 has a local maximum value (i.e., a peak). At time point t14, the second data D2(14) of the second original sequence OS2 has a local minimum value (i.e., a valley). The profile of the second original sequence OS2 is substantially similar to that of the first original sequence OS1, i.e., both have local maximum values around time point t6. However, the second original sequence OS2 may lead or lag the first original sequence OS1 on the time axis, or, the time sequences length of the second original sequence OS2 may be different from that of the first original sequence OS1. Therefore, a dynamic time warping (DTW) operation may be performed to align the first original sequence OS1 with the second original sequence OS2 corresponding to the time axis.

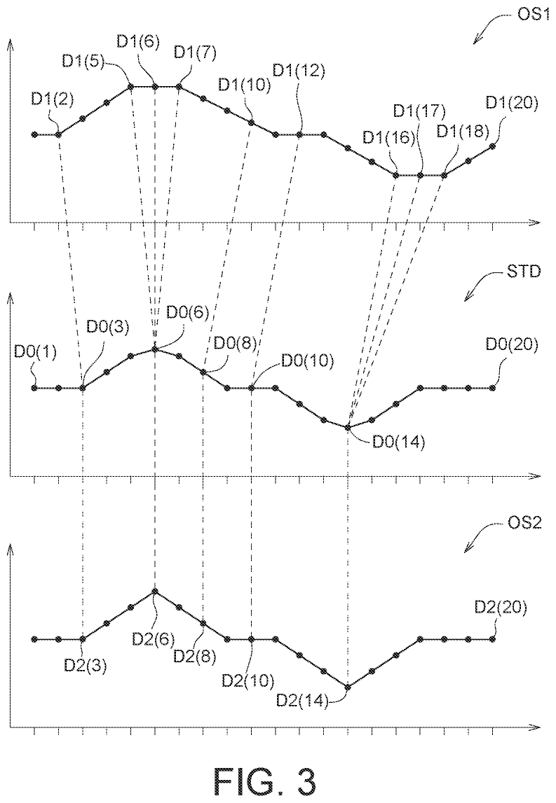

FIG. 2 is a schematic diagram of the DTW operation performed by the first original sequence OS1 and the second original sequence OS2. In one example, the DTW operation may be performed according to the trend of value changing of the first original sequence OS1 and the second original sequence OS2. As shown in FIG. 2, taking the time sequences length N=20 as an example, the horizontal segment D1(1)˜D1(2), the incremented segment D1(2)˜D1(5), the local maximum values D1(5)˜D1(7) (i.e., the peak), the decremented segment D1(7)˜D1(11), horizontal segment D1(11)˜D1(13), decremented segment D1(13)˜D1(16), local minimum values D1(16)˜D1(18) (i.e., valley), incremented segment D1(18)˜D1(20) of the first data D1(1)˜D1(20) of the first original sequences OS1 may be located according to the trend of value changing of the first original sequences OS1.

On the other hand, the horizontal segments D2(1)˜D2(2), Incremented segment D2(2)˜D2(6), local maximum value D2(6) (i.e., peak), decremented segment D2(6)˜D2(9), horizontal segment D2(9)˜D2(11), decremented segments D2(11)˜D2(14), local minimum value D2(14) (i.e., valley), incremental segments D2(14)˜D2(17) of the second data D2(1)˜D2(20) of the second original sequences OS2 may be located according to the trend of value changing of the second original sequences OS2.

Then, on the time axis, the local maximum values D1(5)˜D1(7) (i.e., the peaks) of the first original sequence OS1 are aligned with the local maximum value D2(6) (i.e., the peak) of the second original sequence OS2. And, the local minimum values D1(16)-D1(18) (i.e., valleys) of the first original sequence OS1 are aligned with the local minimum value D2(14) (i.e., valley) of the second original sequence OS2.

Similarly, the incremented segments D1(2)˜D1(5) and the incremented segments D1(18)˜D1(20) of the first original sequence OS1 are respectively aligned with the incremented segments D2(3)˜D2(6) and the incremental segment D2(14)˜D2(17) of the second original sequence OS2. In addition, the decremented segments D1(7)-D1(11) and the incremented segments D1(13)-D1(16) of the first original sequence OS1 are respectively aligned with the incremented segments D2(6)-D2(9) and the increment segment D2(11)˜D2(14). Furthermore, the horizontal segments D1(11)-D1(13) of the first original sequence OS1 are aligned with the horizontal segments D2(9)-D2(11) of the second original sequence OS2.

After the DTW operation is performed to align the first original sequence OS1 and the second original sequence OS2 on the time axis, a normalize operation may be selectively performed on the first original sequence OS1 and the second original sequence OS2 according to actual requirements, so as to adjust the numerical range of the first data D1(1)-D1(20) of the first original sequence OS1 and the second data D2(1)-D2(20) of the second original sequence OS2.

After performing the DTW operation and selectively performing the normalize operation, an averaging operation is performed according to the aligned first data D1(1)˜D1(20) of the first original sequence OS1 and the second data D2(1)˜D2(20) of the second original sequence OS2 to establish a standard sequence. An example of the averaging operation on the first original sequence OS1 and the second original sequence OS2 is: a DTW-based barycenter average operation (DBA).

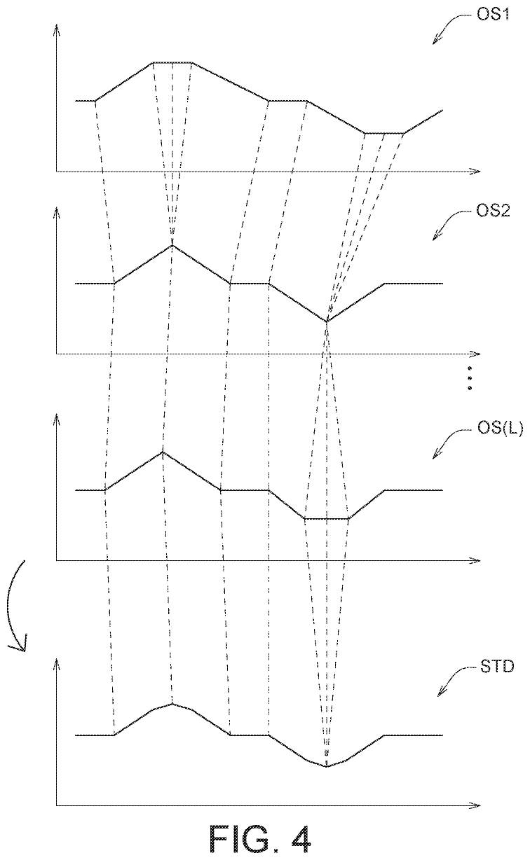

FIG. 3 is a schematic diagram of the DBA operation performed on the first original sequence OS1 and the second original sequence OS2. As shown in FIG. 3, when the DBA operation is performed, the corresponding first data and the second data are located according to the alignment relationship between the first original sequence OS1 and the second original sequence OS2 on the time axis, and an average value of the corresponding first data and second data is calculated. For example, the first data D1(2) of the first original sequence OS1 is aligned with the second data D2(3) of the second original sequence OS2, and the average value D0(3) of the first data D1(2) and the second data D2(3) is calculated, as shown in equation (1):

D0(3)=(D1(2)+D2(3))/2 (1)

And, the local maximum value of the first original sequence OS1 is the first data D1(6), which is aligned with the local maximum (i.e., the second data D2(6)) of the second original sequence OS2, therefore, the average value D0(6) of the first data D1(6) and the second data D2(6) is calculated as shown in equation (2):

D0(6)=(D1(6)+D2(6))/2 (2)

Furthermore, the local minimum value of the first original sequence OS1 is the first data D1(17), which is aligned with the second data D2(14) of the local minimum of the second original sequence OS2, therefore, the average value D0(14) of the first data D1(17) and the second data D2(14) is calculated as the equation (3):

D0(14)=(D1(17)+D2(14))/2 (3)

Similarly, calculate the average value D0(8) of the first data D1(10) and the aligned second data D2(8), as shown in equation (4):

D0(8)=(D1(10)+D2(8))/2 (4)

Based on the above, average values are calculated for all the first data and the respective aligned second data to obtain a plurality of average values D0(1)-D0(20). Then, a standard sequence STD is established according to the average values D0(1)˜D0(20). The standard sequence STD may be regarded as a profile that the first original sequence OS1 and the second original sequence OS2 should have under normal conditions.

Then, difference between the first original sequence OS1 and the standard sequence STD is calculated to evaluate the degree of deviation of the first original sequence OS1 from the standard sequence STD, so as to determine whether the first original sequence OS1 has an abnormal condition. For example, the difference value dD1(2) between the first data D1(2) of the first original sequence OS1 and the corresponding average value D0(3) of the standard sequence STD is shown in equation (5):

dD1(2)=D1(2)−D0(3) (5)

Similarly, the difference value dD1(6) between the first data D1(6) of the first original sequence OS1 and the corresponding average value D0(6) of the standard sequence STD is shown in equation (6):

dD1(6)=D1(6)-D0(6) (6)

Based on the above, the difference value dD1(n) between each of the first data D1(n) of the first original sequence OS1 and the corresponding average value of the standard sequence STD is calculated. Then, these difference values dD1(n) are summed up to obtain a total difference value dD1_{T} (which may be referred to as a “first total difference value”), as shown in equation (7):

dD1_{T}=ΣₙdD1(n) (7)

The total difference value dD1_{T} may represent the degree of deviation of the first original sequence OS1 from the standard sequence STD, and reflects the degree of abnormality of the first parametric variable P1, that is, the degree of “behavior deviation” of the first parameter variable P1.

Based on the same operating method, the difference between the second original sequence OS2 and the standard sequence STD is calculated, so as to evaluate the degree of deviation of the second original sequence OS2 from the standard sequence STD. For example, the difference value dD2(6) between the second data D2(6) of the second original sequence OS2 and the corresponding average value D0(6) of the standard sequence STD is calculated as shown in equation (8):

dD2(6)=D2(6)−D0(6) (8)

The difference value dD2(n) between each of the second data D2(n) of the second original sequence OS2 and the corresponding average value of the standard sequence STD is calculated successively. Then, the difference values dD2(n) are summed up to obtain a total difference value dD2_{T} (which may be referred to as the “second total difference value”), as shown in equation (9):

dD2_{T}=ΣₙdD2(n) (9)

The total difference value dD2_{T} may represent the degree of deviation of the second original sequence OS2 compared to the standard sequence STD, which reflects the degree of abnormality (degree of behavioral deviation) of the second parameter variable P2.

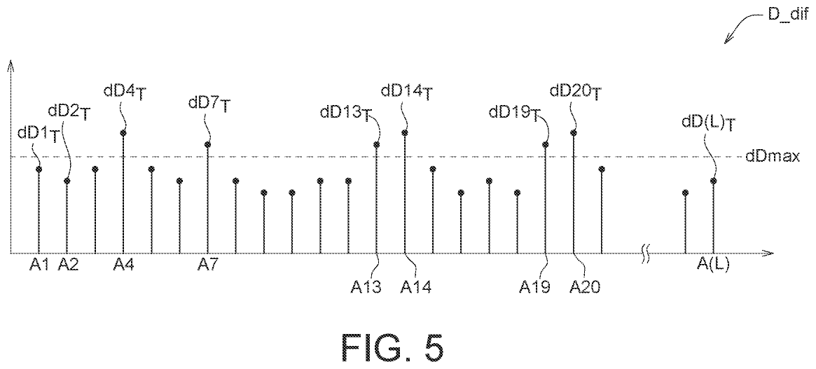

The above embodiments are described by taking two original sequences OS1 and OS2 as examples. When the fault detection method of the present disclosure intends to analyze L targets (i.e., the first target A1, the second target A2, . . . , the Lth target A(L)), a plurality of original sequences OS1˜OS(L) related to L targets are performed with DBA operation to obtain the standard sequence STD, is shown in FIG. 4.

Based on the above calculation method of the total difference value dD1_{T} and the total difference value dD2_{T}, the total difference values dD1_{T}, dD2_{T}, . . . , dD(L)_{T} are calculated for all L original sequences OS1, OS2, . . . , OS(L). Then, a total difference sequence D_dif is established according to the total difference values dD1_{T}, dD2_{T}, . . . , dD(L)_{T}.

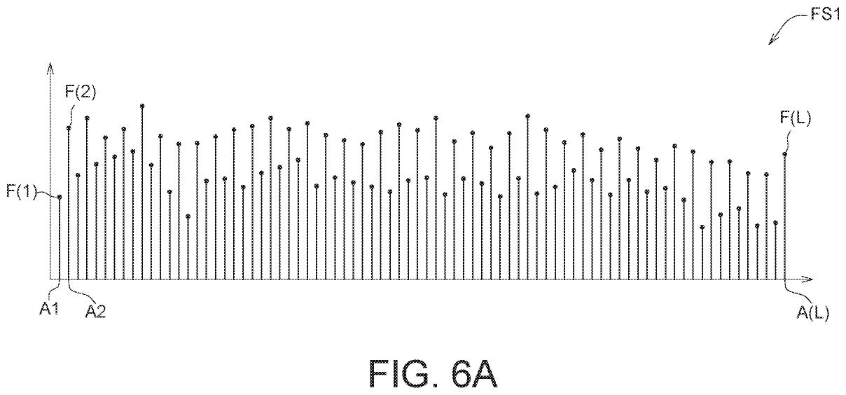

FIG. 5 is a schematic diagram of the total difference sequence D_dif established by the total difference values dD1_{T}˜dD(L)_{T} between the plurality of original sequences OS1˜OS(L) and the standard sequence STD in FIG. 4. As shown in FIG. 5, the total difference sequence D_dif is used for fault detection of the first to the Lth targets A1″A(L). In the total difference sequence D_dif, it may be evaluated whether the total difference value dD1_{T}˜dD(L)_{T} corresponding to the first to the Lth targets A1˜A(L) are greater than the upper limit value dDmax, so as to determine whether the parametric variables of the processes of the first to the Lth targets A1˜A(L) have abnormal conditions (i.e., behavior deviations).

For example, the total difference value dD4_{T} corresponding to the fourth target A4 is greater than the upper limit value dDmax, and the total difference value dD7_{T} corresponding to the seventh target A7 is greater than the upper limit value dDmax, indicating that the parameter variables of the processes of the fourth target A4 and the seventh target A7 have abnormal conditions. Similarly, the total difference values dD13_{T}, dD14_{T}, dD19_{T} and dD20_{T} corresponding to targets A13, A14, A19 and A20 are greater than the upper limit value dDmax, indicating that the parameter variables of processes of the targets A13, A14, A19 and A20 are abnormal.

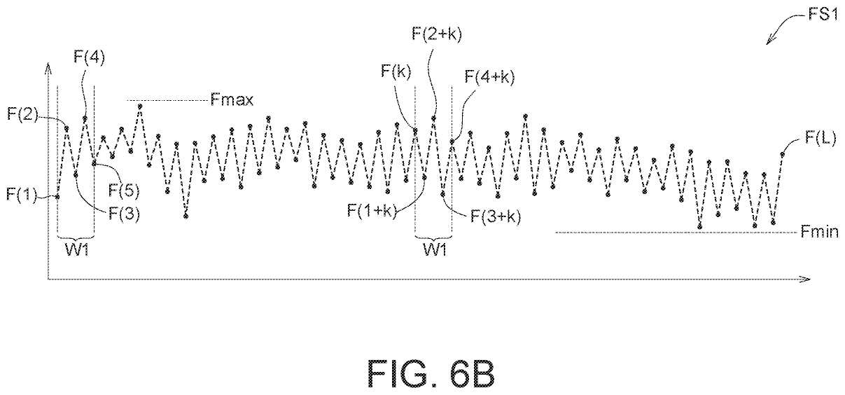

When the numerical range of the data of the target sequence to be analyzed (for example, the original sequences OS1-OS(L)) do not change significantly, behavior deviation of the profile of the target sequences may be detected by the above embodiments in FIGS. 1-5. On the other hand, when the numerical ranges of the data of the target sequences to be analyzed have a significant change (for example, the numerical variation of the data is large), abnormal conditions of the target sequences may be detected by the following embodiments in FIGS. 6A-9.

FIGS. 6A and 6B are schematic diagrams of the target sequence FS1. Referring to FIGS. 6A and 6B, the target sequence FS1 includes a plurality of data F(1)˜F(L), corresponding to the first to the Lth targets A1˜A(L) respectively. In one example, the data F(1)″F(L) may be parameter values of the processes of the first to the Lth targets A1″A(L). In another example, the data F(1)˜F(L) may be the total difference values dD1_{T}˜dD(L)_{T} of the original sequences OS1˜OS(L) corresponding to the first to the Lth targets A1˜A(L) compared with the standard sequence STD.

As shown in FIG. 6B, the data F(1)˜F(L) of the target sequence FS1 has a large numerical variation (that is, the data F(1)˜F(L) has a large fluctuation range), and it is not easy to set a reasonable upper or lower limits of data F(1)˜F(L). For example, only possible upper limit value Fmax or possible lower limit value Fmin may be roughly set, but the upper limit value Fmax and the lower limit value Fmin are not necessarily within a reasonable range. In addition, when the data F(1)˜F(L) have discontinuous “jump points”, such “jump points” are not easy to be detected due to the large numerical variation of the data F(1)˜F(L).

In response to the large numerical variation of the data F(1)˜F(L), average operations may be performed on the data F(1)˜F(L), and then the data F(1)˜F(L) are performed with filter-processing. An example of the average operation is a moving average (MA) operation. A first moving window W1 may be defined to perform a first moving average operation on the data F(1)-F(L). The first moving window W1 has a first width, and the first width is “5” for example. The first moving window W1 may cover a first amount of data F(1)-F(5). The first amount is “5” and is equal to the first width. And, average value M1(1) of the first amount of data F(1)˜F(5) is calculated as shown in equation (10):

M1(1)=(F(1)+F(2)+F(3)+F(4)+F(5))/5 (10)

Then, the first moving window W1 is shifted backward by one data, so that the first moving window W1 covers the first amount of data F(2)-F(6). And, calculate the average value M1(2) of data F(2)˜F(6), as shown in equation (11):

M1(2)=(F(2)+F(3)+F(4)+F(5)+F(6))/5 (11)

Similarly, the first moving window W1 is shifted backward by (k-1) data, so that the first moving window W1 covers the first number of data F(k)˜F(4+k), and average value M1(k) of the data F(k)˜F(4+k) is calculated as shown in equation (12):

M1(k)=(F(k)+F(1+k)+F(2+k)+F(3+k)+F(4+k))/5 (12)

Then, the first moving window W1 is shifted backwards successively, and the average value of the first amount of data in the first moving window W1 is calculated. According to the above-mentioned first moving average operation, a plurality of average values M1(1)˜M1(L) are obtained, and a first moving average sequence MS1 is established according to the average values M1(1)˜M1(L).

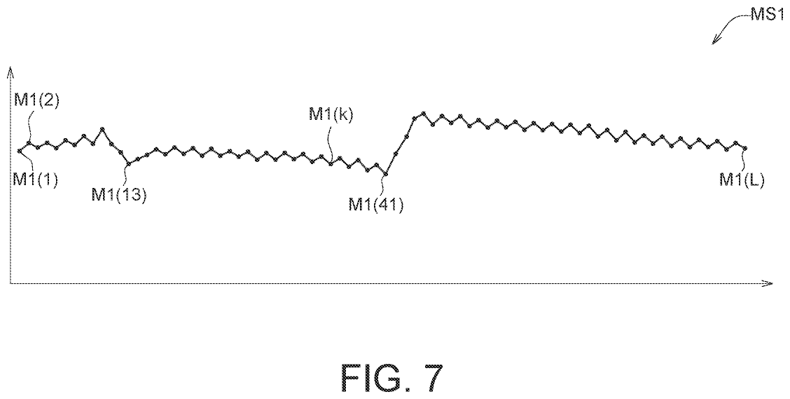

FIG. 7 is a schematic diagram of a first moving average sequence MS1 obtained by performing a first moving average operation on the target sequence FS1 of FIGS. 6A and 6B. The first moving average sequence MS1 includes average values M1(1)˜M1(L). Compared with the numerical variation of the data F(1)˜F(L) of the target sequence FS1 in FIG. 6B, after the first moving average operation, numerical variation of the average values M1(1)˜M1(L) in the first moving average sequence MS1 of FIG. 7 is greatly reduced, showing a smooth trend of value changing, which may effectively reduce the fluctuation amplitude. In addition, it may be observed from the first moving average sequence MS1 that discontinuous “jump points” may exist at the positions of the average value M1(13) and the average value M1(41).

On the other hand, a second moving window W2 may be defined, and a second moving average operation maybe performed on the target sequence FS1 according to the second moving window W2 (not shown in FIG. 6B). The second moving window W2 has a second width, and the second width is not equal to the first width, and the second width is “10”, for example. The second moving window W2 may cover a second amount of data F(1)-F(10). The second amount is “10” and is equal to the second width. And, calculate the average value M2(1) of the second amount of data F(1)˜F(10), as shown in equation (13):

$$M 2 ( 1 ) = \frac{{\sum }_{i = 1}^{10} F ( i )}{10} \qquad ( 13 )$$

Then, the second moving window W2 is shifted backward by one data to cover the second amount of data F(2)-F(11). And, calculate the average value M2(2) of data F(2)˜F(11), as shown in equation (14):

$$M 2 ( 2 ) = \frac{{\sum }_{i = 1}^{10} F ( i + 1 )}{10} \qquad ( 14 )$$

Similarly, the second moving window W2 is shifted backward by (k-1) data to cover the second amount of data F(k)″F(9+k). And, the average value M2(k) of the data F(k)˜F(9+k) is calculated, as shown in equation (15):

$$M 2 ( k ) = \frac{{\sum }_{i = 1}^{10} F ( i + k - 1 )}{10} \qquad ( 15 )$$

Similarly, according to the above-mentioned second moving average operation, a plurality of average values M2(1)˜M2(L) may be obtained. Then, a second moving average sequence MS2 is established according to the average values M2(1)˜M2(L).

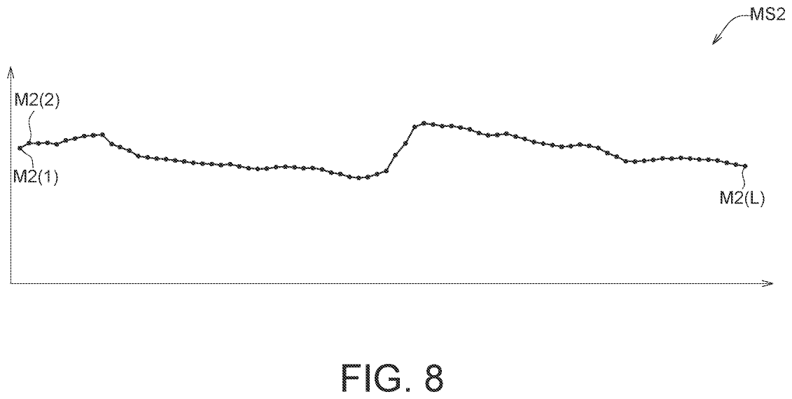

FIG. 8 is a schematic diagram of a second moving average sequence MS2 obtained by performing a second moving average operation on the target sequence FS1 of FIGS. 6A and 6B. The second moving average sequence MS2 includes average values M2(1)-M2(L). Compared with the first moving average sequence MS1 of FIG. 7, after the second moving average operation with a second width of “10” (greater than the first width of “5”), the second moving average sequence MS2 of FIG. 8 reflects a smoother trend of value changing.

Then, the difference between the first moving average sequence MS1 of FIG. 7 and the second moving average sequence MS2 of FIG. 8 is further calculated to obtain the difference sequence M_dif.

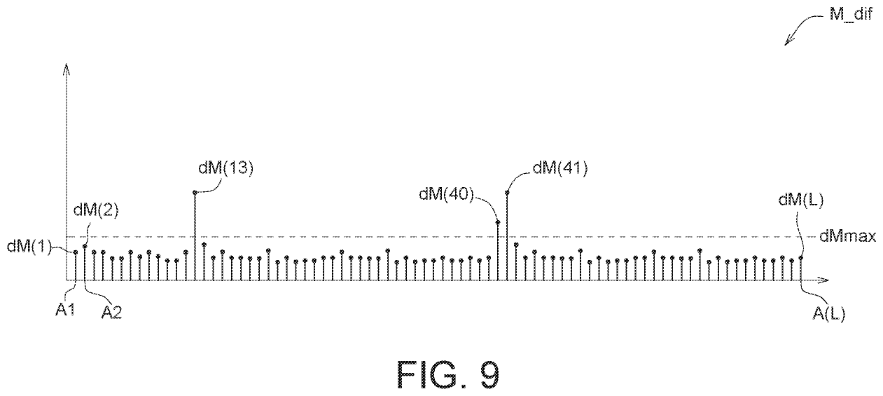

FIG. 9 is a schematic diagram of the difference sequence M_dif between the first moving average sequence MS1 and the second moving average sequence MS2. As shown in FIG. 9, the difference sequence M_dif includes a plurality of difference values dM(1), dM(2), dM(L). The difference value dM(1) is the difference value between the average value M1(1) in the first moving average sequence MS1 and the average value M2(1) in the second moving average sequence MS2, and the difference value dM(2) is the difference value between the average value M1(2) in the first moving average sequences MS1 and the average value M2(2) in the second moving average sequences MS2, and so on.

Through two moving average operations with different widths of moving windows, the short-term value fluctuation of the target sequence FS1 may be reduced, so as to highlight the long-term trend of value changing. Moreover, by subtracting the results of the two moving average operations, the discontinuous “jump point” situation of the target sequence FS1 may be highlighted. The numerical variation of the difference sequence M_dif is much smaller than the target sequence FS1, which benefit setting of a reasonable upper limit value dMmax of the difference sequence M_dif.

In the difference sequence M_dif, the difference values dM(13), dM(40) and dM(41) are detected to be greater than the upper limit value dMmax. The difference values dM(13), dM(40) and dM(41) correspond to the discontinuous “jumping points” of the first and second moving average sequences MS1 and MS2 of FIGS. 7 and 8.

It will be apparent to those skilled in the art that various modifications and variations may be made to the disclosed embodiments. It is intended that the specification and examples be considered as exemplary only, with a true scope of the disclosure being indicated by the following claims and their equivalents.

What is claimed is:

1. A fault detection method, comprising:
receiving a target sequence, the target sequence comprises a plurality of data;
performing a first moving average operation on the target sequence to establish a first moving average sequence;
performing a second moving average operation on the target sequence to establish a second moving average sequence;
performing a difference operation between the first moving average sequence and the second moving average sequence to obtain a difference sequence, the difference sequence comprises a plurality of difference values;
setting an upper limit value; and
when one of the difference values is greater than the upper limit value, determining that the target sequence is abnormal.

2. The fault detection method according to claim 1, wherein:
the first moving average operation is performed according to a first moving window, the first moving window has a first width; and
the second moving average operation is performed according to a second moving window, the second moving window has a second width, and the second width is not equal to the first width.

3. The fault detection method according to claim 2, wherein, the step of performing the first moving average operation on the target sequence comprises:
in the target sequence, covering a first amount of the data with the first moving window, the first amount is equal to the first width;
performing an average operation on the first amount of the data;
shifting the first moving window backwards successively; and
performing another average operation on the data which are covered by the shifted first moving window.

4. The fault detection method according to claim 2, wherein, the step of performing the second moving average operation on the target sequence comprises:
in the target sequence, covering a second amount of the data with the second moving window, the second amount is equal to the second width;
performing an average operation on the second amount of the data;
shifting the second moving window backwards successively; and
performing another average operation on the data which are covered by the shifted second moving window.

5. The fault detection method according to claim 1, wherein, when one of the difference values is greater than the upper limit value, determining that positions of the target sequence corresponding to the difference values greater than the upper limit value have discontinuous conditions.

6. The fault detection method according to claim 1, wherein a numerical variation of the difference sequence is smaller than a numerical variation of the target sequence.
